(19) United States
(12) Patent Application Publication
(10) Pub. No.: US 2003/0023981 A1
(43) Pub. Date: Jan. 30, 2003

(54) Method and apparatus for transmission of interactive and enhanced television data

(76) Inventor: Thomas Lemmons, Evergreen, CO (US)

Correspondence Address: COCHRAN & COLLINS, LLP, Suite 230, 3555 Stanford Road, Fort Collins, CO, 80525, US

(21) Appl. No.: 09/915,114

(22) Filed: Jul. 25, 2001

(51) Int. Cl. H04N 7/173

(52) U.S. Cl. 725/109; 725/135; 725/136

(57) ABSTRACT

A television program is transmitted on a first channel and enhancements to the program are broadcast on a second channel. The first channel comprises a video service channel. The second channel may comprise an out-of-bounds (OOB) channel, a non-service channel, or a non-utilized service channel. Enhancements may be extracted from video information containing program content and enhancements. Channel, timing, and control information may be combined with enhancements prior to transmission. Combination may conform to extensions to the Advanced Television Enhancement Forum (ATVEF) specification. A receiver may store part of the enhancements and may render enhancements in response to channel, timing, or control information. Enhancements may be compressed prior to transmission. A receiver may compress enhancements. A receiver may comprise an adjustable tuner operable to receive the second channel. Adjustment of the tuner may be in response to received information or a software program in the receiver.

### BACKGROUND OF THE INVENTION

a. Field of the Invention

The present invention relates to interactive and enhanced television and more particularly to a method and system of transmitting television content and television enhancements.

b. Description of the Background

A television program may be accompanied by additional information employed to enhance the program. Such enhancements have historically included closed captioning and multilingual support. Advances in networking, computer systems, and video production have increased the number and types of enhancements that may be provided with a program or advertisement. Enhancements may include stock updates, news stories, Internet links, weather forecasts, bulletins, and other information, for example. Further, the advent of set-top-boxes, as may be used in cable and satellite television systems, allows enhancement information to be presented in new ways, such as screen overlays and windows, for example.

Conventionally, enhanced television content is broadcast on the same channel as is used for the program. Television signal broadcast employs a fixed frequency range, or channel, to carry signals for each program. In the United States, NTSC analog broadcast, including analog cable television, employs a 6 MHz band for each channel. The broadcast program typically utilizes a significant portion of the available bandwidth within a channel, therefore limiting the amount of bandwidth available for enhanced content. The limited bandwidth available for enhanced program content constrains the amount of data that may be employed to enhance a program, limiting the type of enhancement that may be provided, and curtailing opportunities for increased viewer enjoyment and greater revenue generation. As such, a new system and method for delivering interactive and enhanced television data is needed.

### SUMMARY OF THE INVENTION

The present invention overcomes the disadvantages and limitations of the prior art by providing a system and method wherein enhanced content may be broadcast on a channel that is independent and separate from the channel employed to broadcast program content.

The present invention therefore comprises a method of transmitting television content and television enhancements comprising: transmitting a video program employing a first channel operating at a first frequency; and transmitting enhancement data employing a second channel operating at a second frequency.

The invention may further comprise a system for transmitting television content and television enhancements comprising a head-end system, a transmitter, a network and a receiver operable to receive a video program on a first channel and operable to receive enhancement data on a second channel.

Employing a separate channel to broadcast enhancement data provides higher bandwidth for transmitting such data. Higher bandwidth allows more programs to be enhanced, allows higher resolution or more complex enhancements, allows more versions of enhancements (such as foreign languages, for example), and may be employed to transmit enhancements independent of the program being displayed. Enhancement independent of the program displayed may be employed to provide interactive entertainment, contests, promotions, or advertising not associated with a video program. As such, the method and system of the present invention provides an opportunity for greater viewer choice, greater viewer enjoyment and increased revenue generation.

### BRIEF DESCRIPTION OF THE DRAWINGS

In the drawings;

FIG. 1 depicts a television broadcast system.

FIG. 2 is illustrative of the NTSC frequency map for standard 6-MHz television channel bands in North America.

FIG. 3 depicts a method of transmitting television content and television enhancements.

FIG. 4 depicts another method of transmitting television content and television enhancements.

### DETAILED DESCRIPTION OF THE INVENTION

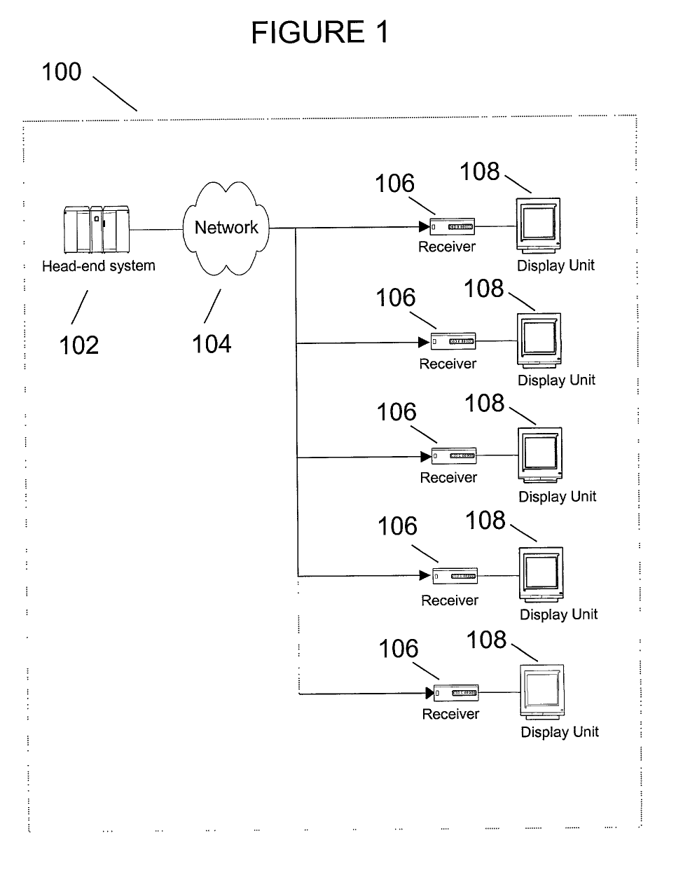

FIG. 1 depicts a television broadcast system 100 comprising head-end system 102, network 104, receivers 106, and display units 108. Head-end system 102 delivers television programming to the receivers 106, via network 104. Head-end system 102 may comprise components from R. L. Drake Company located at 230 Industrial Drive, Franklin Ohio 45005 U.S.A. or components from Cisco Systems Inc., located at 170 West Tasman Dr. San Jose, Calif. 95134 USA.

Network 104 may comprise fiber optic, coaxial cable, terrestrial or satellite transmission, or combinations thereof, as is common to the art. Receivers 106 convert the incoming programming information into a format appropriate for input to display units 108, and thus for viewing by end users of the system 100. Receivers 106 may comprise set-top boxes, personal computers, interactive televisions, or other equipment operable to process television signals and other information, such as control information and program guides, for example. Display units 108 may comprise televisions, computer monitors, or other devices operable to display video images.

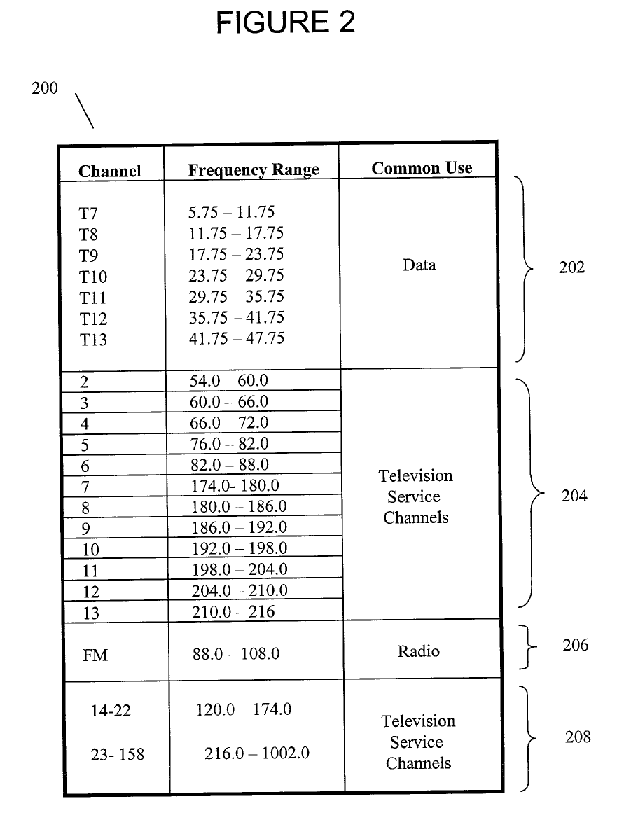

Television broadcast typically employs frequency division multiplexed signals wherein a plurality of programs is broadcast simultaneously, each in a predefined frequency range, or channel. FIG. 2 is illustrative of the NTSC frequency map for standard 6-MHz cable television channel bands in North America. Label 202 of FIG. 2 indicates frequencies that may be employed for data transfer, such as may be utilized by cable modems. Label 204 indicates the frequencies assigned to television channels two through thirteen. Label 206 indicates the frequencies assigned to FM radio. Frequencies indicated by labels 204 and 208 are referred to as service channels. Label 208 indicates frequencies assigned to channels 23 to 158 wherein each channel shares an adjacent 6 MHz band. Other standards, such as Phase Alternating Line (PAL) and Systeme Electronique Couleur Avec Memoire (SECAM) employ an 8-MHz channel band.

Head-end system 102 transmits signals, to receivers 106, comprising a number of predefined video service channels, each video service channel occupying a separate portion of available spectrum. A video service channel is a channel, conforming to a standard, either public or proprietary, that may contain a video program. System 100 transmission typically also includes at least one non-service channel, often referred to as an out-of-band (OOB) channel. The OOB channel may be employed for signaling purposes such as pay-per-view conditional access, management messages, or program guides, for example.

The OOB signaling channel may be a dedicated channel employing a frequency outside that assigned to service channels. In some implementations, the OOB channel may be of lower bandwidth than video service channels, allowing for simpler and less expensive demodulation and decoding of the OOB data. Alternatively, all or part of a video service channel may be employed to transfer OOB data. For example, higher frequency service channels not carrying video programs may be employed to carry OOB data. A receiver may comprise a dedicated tuner employed for OOB communication. In some systems, OOB data may be transmitted on each video service channel such that OOB information is available independent of the channel tuned. The format of data transmitted in the OOB channel may be proprietary and may be encrypted by the system operator.

For enhanced and/or interactive television applications, the head-end system broadcasts program content, that may be stored locally or received across a network, along with enhanced content information. Enhanced content may also be stored locally or received across a network. In a manner similar to television advertisements, enhanced content may comprise television network content or local content tailored to local companies or demographics.

Transfer of enhanced television content may conform to specifications set forth by the Advanced Television Enhancement Forum (ATVEF), a cross-industry group formed to specify a single public standard for delivering interactive television. ATVEF specification v1.1 r26 is specifically incorporated herein by reference for all that it discloses and teaches.

The ATVEF specification defines a format for enhanced content, defines transport methods for transfer of enhanced content, and defines signaling formats. Format and transport sections of the ATVEF specification address delivery of enhanced data resources, such as HTML pages, JAVA scripts, bitmaps, and messages, for example. Signaling formats address display of enhanced content resources synchronized by and in response to triggers.

Triggers are mechanisms employed to signal a receiver of content enhancements. ATVEF compliant triggers are sent as part of the broadcast stream and contain information about enhancements that are available to the user. Among other information, a trigger contains a standard Universal Resource Locator (URL) that defines the location of enhanced content. ATVEF compliant content may be stored locally at the receiver, after being delivered over the broadcast network to a receiver, or enhanced content may reside on a network such as the Internet, other public networks, or private networks, for example.

In addition to providing information describing the location of enhancement information, triggers may optionally contain a human-readable message that may be employed to describe enhanced content or prompt a user to access information. For example, trigger may contain a description such as, “Press Browse for more information about this program”, that may be displayed in order to provide information about the nature of the program or enhanced content to the user. Triggers may also contain expiration information that provides the receiver with information indicating how long the content should be offered to the viewer. A checksum is provided to check the integrity of the delivered information. Triggers may also include JavaScript fragments. Such script fragments, that may comprise single method calls, may be employed to trigger execution of a JavaScript within an associated HTML page, and may be used for other tasks, such as synchronization of the enhanced content with the video signal or updating of dynamic screen data, for example.

A television broadcast system as shown in FIG. 1 may support one-way or two-way communications. The ATVEF specification defines two models of transport: Transport A and Transport B. In Transport A, triggers are broadcast from the head-end to the receiver and the receiver accesses enhanced content information through a network connection. URL(s) passed with the trigger provide a pointer to the content. The network connection may comprise an Internet connection such as a dial-up modem, cable modem or other connection. In Transport B, triggers and enhanced content data are contained in the program broadcast. The receiver stores enhanced content information in local memory. Transport B employs announcements that are sent over the network to associate triggers with content streams. Generally, an announcement describes a content stream and the trigger stream, and may include information regarding bandwidth, storage requirements, and language wherein enhancements may be delivered in multiple languages. In Transport B, the receiver may store enhanced content information contained in the video service channel and may employ announcement information to allocate receiver storage capacity. For example, if a content stream requires more free storage space than a particular receiver has available, the receiver may overwrite older content, or not store the enhanced content. In analog systems, enhanced data and/or triggers may be transmitted in Vertical Blanking Interval (VBI), in addition to closed caption and control information that is common to present broadcast formats.

In contrast to the ATVEF specification, the present invention does not require that video service channels contain enhanced data and/or triggers. In one embodiment, enhanced data transfer and triggers may employ a non-service channel, such as the OOB signaling channel, or a non-utilized service channel. In another embodiment, triggers are broadcast in the service channel and enhancement information is broadcast on a non-service channel, such as the OOB channel, or on a non-utilized service channel. Advantageously, use of the OOB channel, other non-service channel, or non-utilized service channel allows higher data transfer rates for enhanced content than is available through ATVEF compliant systems. The higher data transfer rates of the present invention may be employed to broadcast enhancement information for a greater number of video programs, may be used to provide a larger amount of data for the enhancement of a program, and may be employed to broadcast auxiliary content. Auxiliary content may comprise enhancement not associated with a specific video program, such as games, news and weather, for example. Further, auxiliary content may be employed in conjunction with contests, vendor coupons, or other material, providing a new avenue of viewer enjoyment and potential revenue generation.

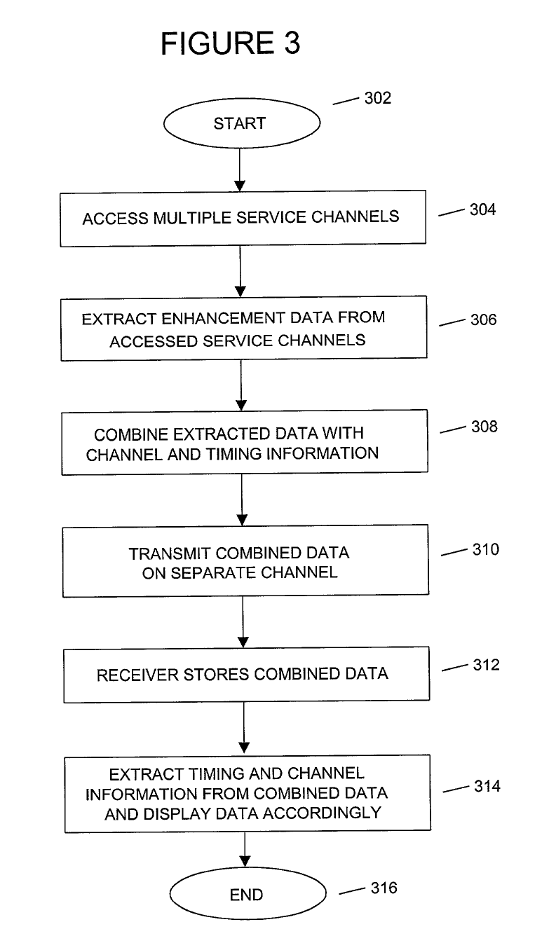

FIG. 3 depicts a method of transmitting television content and television enhancements. Head-end system 102 accesses, at step 304, multiple channels of video information including at least one service channel containing enhancement data that may comprise content and triggers. Such access may employ network communications, may employ satellite communications, or may employ local storage, and content accessed may comprise local content and content from commercial data providers, such as television and cable networks. Further, the term “access” refers to any method of information transfer, solicited or unsolicited, initiated by the head-end system or initiated by another system, real-time, near real-time or non real-time, and of any rate, frequency, or format.

At step 306, enhancement data is extracted from service channels containing enhancement data. The extracted enhancement data may be stored, may be discarded, may be altered, or may be replaced by other enhancement data stored locally or accessed employing a network. At step 308, enhanced data, either extracted from an accessed service channel or accessed from local storage or a network, may be combined with channel and timing information to allow synchronization with a video program. Combined data may comprise data compliant with the ATVEF specification with extensions for execution time and channel information. Extensions may be employed to indicate the channel and time at which enhanced data may be utilized. Time information may specify a start time, a range of time, or no specific time such that, based on a program attribute, such as a program ID, the enhancement may be configured to occur at any time during the program, possibly in response to a user input. Time information may employ time-of-day information that may be present in an OOB channel, or may employ video frame numbers. Further, extensions may list multiple time and channel combinations so that an enhancement may be applied, for example, to a single program or advertisement that appears on different channels at different times. Alternatively, the extensions can specify only select times to indicate, for example, that the corresponding enhancement is to be displayed at the specified time, independent of the channel being viewed. Additionally, extensions may specify that an enhancement be displayed only if one of a predefined set of channels is being viewed.

At step 310, the combined data is transmitted employing an OOB channel, other non-service channel, or non-utilized service channel of the broadcast system, and at step 312, receivers 106 receive and may locally store part or all of the combined data in a hard drive, memory array, or other storage medium associated with the receiver. Since local storage capacity of receivers may be limited, the receiver may compress combined data prior to storage. Alternatively, combined data may be compressed prior to transmission and stored in a compressed format in the receiver until utilized. Data for an enhancement is transmitted before a corresponding trigger is transmitted. The receiver may employ algorithms to track utilization of combined data and limit the amount of combined data to be stored. For example, the receiver may be configured not to store combined data that is not utilized, such as data for channels not presently being viewed or data associated with enhancements not enabled such as foreign language enhancements.

Referring again to FIG. 3, at step 314, the receiver may determine if stored combined data corresponds to a currently viewed service channel and if enhancements are enabled. When stored combined data corresponds to a currently viewed channel and enhancements are enabled, the receiver may employ timing, trigger and enhancement data to render the enhancement The receiver comprises a first tuner set to a frequency to receive a video program on a service channel and a second tuner set to frequency to receive enhancement data on an OOB channel, non-active service channel, or other channel. Tuner refers to analog and/or digital circuitry, or a combination thereof, which receives a signal at a defined frequency. The aforementioned first tuner and second tuner may be implemented as a software algorithm on a DSP processor. The receiver also comprises a software algorithm operable to transfer enhancement data from the OOB channel, non-service channel, or non-active service channel to local memory. When a trigger is received, enhanced content information is accessed in receiver local memory and may be employed to render audio and/or video output.

As noted previously, broadcast systems may support two-way communications. Downstream communications may be used to transfer programs and enhanced content. Upstream communications may be used to support interactive use, such as participation in game shows, for example. Further, some receivers may support tuning of the channel employed to receive enhancement data. As such the enhancement channel may comprise an OOB channel, a non-service channel, or a non-active service channel. Such tuning may be in response to information contained in a service channel or currently tuned enhancement channel, or may be in response to a software program executed within the receiver. For example, a video program transmitted on a service channel may include information specifying an enhancement channel on which enhanced content may be received. The ability to tune the OOB channel allows for the OOB channel to be tuned to a channel with enhanced content for the currently viewed program. A plurality of enhanced content channels may contain enhancement data for a plurality of programs. Further, one enhancement channel may contain enhancement information for more than one video program. Additionally, different levels of enhancement may be broadcast, depending whether the enhancement is broadcast on the same channel as the video program, on a separate channel with other enhancements or information, or on a channel dedicated to enhance one video program.

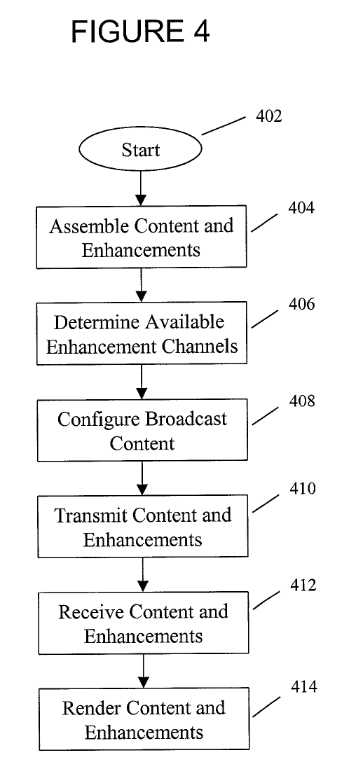

FIG. 4 depicts another method of transmitting television content and television enhancements. At step 404, content and enhancements are assembled in preparation for broadcast by the head-end system. The assembly process may comprise scheduling of stored and/or real-time information including content, enhancements, and other information. Real-time information may be transferred across a network, as may be employed for television or cable network feeds. Other information may comprise on-screen channel guides and pay-per-view movie information, for example. The assembly process may also comprise extracting enhanced content information from video program information. Extracted enhanced content information may be deleted, may be altered, may be broadcast on a different channel, partially on a different channel, or may be replaced by other content information, such as local enhancement for a national advertisement wherein the local enhancement may comprise local dealer or store information.

Triggers may be modified or extracted from video program information. For example, ATVEF compliant Type A transport trigger URLs may be modified to change enhancement information employed, allowing for localized versions of enhancements. Also, trigger URLs may be modified and enhancement data extracted to convert ATVEF type B transport to ATVEF type A transport. Additionally, an ATVEF type B transport format may be accompanied by additional or alternate enhancement information broadcast on a channel different from the service channel carrying type B information. Receivers having a capability to receive information on two channels (a service channel and an enhancement channel, for example) may be configured to receive enhancements on an OOB, non-service channel, or non-utilized service channel, allowing for more detailed enhancement, while receivers having a single tuner capability may receive enhancements on the service channel. In this manner, a broadcaster may accommodate receivers having different capabilities. Further yet, a receiver may be configured to employ a URL modification algorithm wherein trigger URL addresses are modified to point to another location. Such modification may alter only website (base address) information of the URL, allowing a plurality of versions to be selected by the user.

Continuing with the description of step 404 of FIG. 4, the assembly process may further comprise assigning video feeds to individual channels and identifying the number of video programs for which there may be enhancements. At step 406, channels available for enhanced content transmission are determined. At step 408, broadcast content is configured. Configuration may comprise assigning enhanced content to available channels. Such assignment may depend in part on receiver capabilities, amount of enhanced content, and type of enhanced content. Further, enhanced content for a video program may comprise more than one version, such as a low bandwidth version and a higher bandwidth version wherein depending on available bandwidth, the configuration of step 408 may select a bandwidth version of enhanced content that reflects available broadcast bandwidth and receiver capabilities, such as channels received and storage capacity, for example.

At step 410, content and enhancements are transmitted. Transmission may conform to ATVEF standards wholly or in part or may employ proprietary formats. At step 412, receivers (106 of FIG. 1) receive content and enhancement information. The receiver may conform to ATVEF specifications or may employ proprietary formats, or a combination of both. In one embodiment, receivers 106 receive enhanced content information on a predefined channel, such as the aforementioned OOB channel, non-utilized video channel, or other channel. The channel containing enhancement information may contain enhancement information for one video program, for a plurality of video programs, or independent of any program. In a second embodiment, enhancement information is broadcast on one or more channels and the receiver may adjust tuning to receive a channel that contains enhancement for a video program. In this embodiment where the receiver may adjust tuning to receive enhancements, the channel containing enhancements may also contain other information normally provided in an OOB channel, such as control information and program guides, for example. Control information may include instructions or other information, such as a video program channel to enhancement channel frequency table, for example, that may be employed to change the frequency of the channel employed to receive enhancements by the receiver. At step 414, the receiver renders content and enhancement information and outputs signals to the display unit.

By transmitting enhancement data via a non-associated channel, such as an OOB signaling channel, the present invention allows use of the enhancement data across multiple video streams, or independent of any particular video stream, such as auxiliary data. The frequencies, modulation and format of service channels, non-service channels and non-utilized service channels are not limited to the foregoing description. Frequency ranges may be different in PAL, SECAM or satellite systems. Further, digital data formats, such as MPEG, for example, may be employed to carry programs and/or enhancement information. A combination of digital and analog technologies may be employed. For example, program broadcast may employ analog formats and enhancement information may employ digital broadcast formats.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

We claim:

1. A method of transmitting television content and television enhancements. comprising:
transmitting a video program employing a first channel operating at a first frequency; and
transmitting enhancement data employing a second channel operating at a second frequency.

2. The method of claim 1 wherein said second frequency does not correspond to the frequency of a service channel.

3. The method of claim 1 wherein said second channel corresponds to a service channel.

4. The method of claim 1, wherein said enhancement data conforms to Advanced Television Enhancement Forum (ATVEF) specifications.

5. The method of claim 1 wherein said second channel is of smaller bandwidth than said first channel.

6. The method of claim 1, wherein the step of transmitting enhancement data further comprises:
transmitting display channel instructions with the enhancement data, wherein said display channel instructions indicate at least one service channel with which said enhancement data may be associated.

7. The method of claim 6, wherein said display channel instructions conform to extensions to the Advanced Television Enhancement Forum (ATVEF) specification.

8. The method of claim 1, wherein the step of transmitting enhancement data further comprises:
transmitting display time instructions with the enhancement data, wherein said display time instructions indicate at least one time at which said enhancement data may be rendered.

9. The method of claim 8, wherein said display channel instructions conform to extensions to the Advanced Television Enhancement Forum (ATVEF) specification.

10. The method of claim 8 wherein said enhanced content may be rendered independent of the channel currently viewed by a user.

11. The method of claim 1 wherein said enhancement data comprises enhanced content and control information wherein said control information includes information describing at least one program channel with which said enhanced content may be rendered.

12. The method of claim 11 wherein said enhanced content may be rendered independent of the channel currently viewed by a user.

13. A method of enhanced television transmission comprising:
transferring video information, compliant with the ATVEF standard for type A transport, to a transmission system;
altering a URL contained in said video information; and
transmitting said video information.

14. The method of claim 13 wherein said step of altering comprises altering only the host name portion of said URL.

15. A method of transmitting television content and television enhancements comprising:
accessing video information containing enhanced content;
removing said enhanced content from said video information to produce non-enhanced video information;
transmitting said non-enhanced video information on a first channel having a first frequency; and
transmitting said enhanced content on a second channel having a second frequency.

16. The method of claim 15 wherein said second frequency does not correspond to the frequency of a service channel.

17. The method of claim 15 wherein said second channel corresponds to a service channel.

18. The method of claim 15 wherein said enhanced content is compressed prior to transmission.

19. The method of claim 15 wherein said transmitting said enhanced content further comprises combining said enhanced content with channel information wherein said channel information indicates at least one program with which said enhanced content may be rendered.

20. The method of claim 15 wherein said step of transmitting further comprises: replacing said enhancement data with other enhancement data.

21. The method of claim 20 wherein said other enhancement data is accessed employing a network connection.

22. The method of claim 21 wherein said other enhancement data is accessed on a near real-time basis.

23. The method of claim 20 wherein said other enhancement data is stored locally to a head-end system.

24. The method of claim 15 wherein said step of transmitting said non-enhanced video information on a first channel further comprises:
transmitting information indicating a channel on which enhancement data may be received.

25. A method of transmitting television content and television enhancements comprising:
accessing video content information;
accessing enhanced content associated with said video content information;
transmitting said video content information on a first channel having a first frequency; and
transmitting said enhanced content on a second channel having a second frequency.

26. The method of claim 25 wherein said second frequency does not correspond to the frequency of a service channel.

27. The method of claim 25 wherein said second channel corresponds to a service channel.

28. The method of claim 25 wherein said enhanced content is compressed prior to transmission.

29. The method of claim 25 wherein said step of transmitting said enhanced content further comprises combining said enhanced content with channel information wherein said channel information indicates at least one program with which said enhanced content may be rendered.

30. The method of claim 29 wherein said enhanced content is compressed prior to transmission.

31. The method of claim 25 wherein said enhancement data is accessed employing a network connection.

32. The method of claim 25 wherein said enhancement data is stored locally to a head-end system.

33. The method of claim 25 wherein said step of transmitting said video content information on a first channel further comprises:
transmitting information indicating a channel on which enhancement data may be received.

34. A system for transmitting television content and television enhancements comprising:
a head-end system;
a transmitter;
a network; and
a receiver operable to receive a video program on a first channel and operable to receive enhancement data on a second channel.

35. The system of claim 34 wherein said head-end system is operable to remove enhancement data from video information containing a video program and said enhancement data.

36 The system of claim 34 wherein said head-end system is operable to broadcast said video program on a first channel and said enhancement data on a second channel.

37. The system of claim 36 wherein said head-end system is operable to combine timing information with said enhancement data.

38. The system of claim 35 wherein said head-end system is operable to replace said enhancement data with other enhancement data.

39. The system of claim 34 wherein said receiver further comprises:
an algorithm in said receiver, responsive to said video program received on said first channel and said enhancement data received on said second channel, operable to output signals to a display unit.

40. The system of claim 39 wherein said receiver further comprises:
an adjustable tuner wherein the frequency of said second channel may be altered.

41. The system of claim 40 wherein said receiver further comprises:
a software program operable to receive information describing the frequency of said second channel and to adjust the frequency of said second channel in response to said information.

42. The system of claim 34 wherein said receiver further comprises:
an algorithm operable to alter a URL.

43. The system of claim 34 wherein said head-end system is operable to modify a URL.

44. The system of claim 34 wherein said receiver further comprises:
an algorithm operable to associate said enhancement data with said video program and to render an output employing said enhancement data.

45. An enhanced television receiver comprising:
a first component operable to receive a signal employing a user selected channel;
a second component operable to receive a signal on a second channel;
a memory; and
an algorithm, responsive to program information received on said user selected channel and enhancement data received on said second channel, operable to affect output of signals to a display unit.

46. The receiver of claim 45 further comprising:
an adjustable component operable to set the frequency of said second channel.

47. The receiver of claim 46 wherein said adjustable component is responsive to information on said user selected channel.

48. The receiver of claim 46 wherein said adjustable component is responsive to an algorithm operating in said receiver.

49. The receiver of claim 48 wherein said algorithm further comprises:
a data structure providing an association between said user selected channel and the frequency of said second channel.

50. The receiver of claim 45 further comprising:
a software program operable to store part of said enhancement data in storage local to said receiver.

51. The software program of claim 50 further comprising:
a routine to allocate said storage employing information contained in said enhancement data.

52. The receiver of claim 50 wherein said software program is further operable to compress part of said enhancement data prior to storage.

53. The receiver of claim 50 wherein said software program is further operable to decompress part of said enhancement.

54. The receiver of claim 50 wherein said software program is further operable to render an enhancement employing time information contained in said enhancement data.

55. The receiver of claim 54 wherein said time information conforms to extensions to Advanced Television Enhancement Forum (ATVEF) specifications.
